(19) United States
(12) Patent Application Publication
(10) Pub. No.: US 2010/0145687 A1
(43) Pub. Date: Jun. 10, 2010

(54) REMOVING NOISE FROM SPEECH

(75) Inventors: Qiang Huo, Beijing (CN); Jun Du, Hefei (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/327,824

(22) Filed: Dec. 4, 2008

(51) Int. Cl. G10L 21/02; G10L 11/04; G10L 11/02

(52) U.S. Cl. 704/206; 704/226; 704/233; 704/211; 704/E15.039; 704/E19.045

(57) ABSTRACT

Method for removing noise from a digital speech waveform, including receiving the digital speech waveform having the noise contained therein, segmenting the digital speech waveform into one or more frames, each frame having a clean portion and a noisy portion, extracting a feature component from each frame, creating an nonlinear speech distortion model from the feature components, creating a statistical noise model by making a Piecewise Linear Approximation (PLA) of the nonlinear speech distortion model, determining the clean portion of each frame using the statistical noise model, a log power spectra of each frame, and a model of a digital speech waveform recorded in a noise controlled environment, and constructing a clean digital speech waveform from each clean portion of each frame.

### BACKGROUND

Enhancing noisy speech for improving listening experience has been a long standing research problem. In order to keep the speech from degrading significantly, many approaches have been proposed to effectively remove noise from the speech. One class of speech enhancement algorithms are derived from three key elements, namely a statistical reference clean-speech model pre-trained from some clean-speech training data, a noise model with parameters estimated from the noisy speech to be enhanced, and an explicit distortion model characterizing how speech is distorted.

The most frequently used distortion model operates in the log power spectra domain, which specifies that the log power spectra of noisy speech are a nonlinear function of the log power spectra of clean speech and noise. The nonlinear nature of the above distortion model makes statistical modeling and inference of the relevant signals difficult. As a result, certain approximations would have to be made. Two traditional approximations, namely Vector Taylor Series (VTS) and Maximum (MAX) approximations, have been used in the past, but each of these approximations has not been very accurate for deriving appropriate procedures to estimate the noise model parameters as well as clean speech parameters.

### SUMMARY

Described herein are implementations of various technologies directed to removing noise from a digital speech waveform. In one implementation, a computer application may receive a clean speech waveform from a user. The clean speech waveform may have been recorded in a controlled environment with a minimal amount of noise. The clean speech waveform may then be segmented into overlapped frames of clean speech in which each frame may include 32 milliseconds of clean speech.

Then a feature component may be extracted from each clean speech frame. First, a Discrete Fourier Transform (DFT) of each clean speech frame may be computed to determine the clean speech spectra in the frequency domain. Using the components of the clean speech spectra (e.g., magnitude component), the log power spectra of each clean speech frame may be calculated to estimate a clean speech model. In one implementation, the clean speech model may include a Gaussian Mixture Model (GMM).

After creating a clean speech model, the computer application may receive a digital speech waveform having noise from a user. The digital speech waveform may then be segmented into overlapped frames of the digital speech waveform where each frame may include 32 milliseconds of the digital speech waveform. One or more feature components from each digital speech waveform frame may then be extracted and its corresponding digital speech spectra may be determined using a Discrete Fourier Transform (DFT).

The feature component, such as its magnitude and phase information, may be stored in a memory, and it may then use the components to calculate the log power spectra of each digital speech waveform's frame. A nonlinear speech distortion model of the digital speech waveform may be approximated as:

exp(y¹)=exp(x¹)+exp(n¹)

where y¹, x¹, and n¹ represent the log power spectra of the digital speech waveform, the clean portion of the digital speech spectra (features), and the noisy portion of the digital speech spectra, respectively.

A nonlinear speech distortion model for the whole digital speech waveform may then be created by assuming that the first few log power spectra frames of the digital speech waveform may be composed of pure noise. Using the nonlinear speech distortion model, a statistical noise model may be created for the whole digital speech waveform. Here, a maximum likelihood (ML) estimation of a mean vector μₙ and a diagonal covariance matrix [symbol] may be made using an iterative Expectation-Maximization (EM) algorithm. In one implementation, the ML estimation may be obtained by using feature components extracted from all of the frames of the digital speech waveform.

In order to calculate the EM algorithms, one or more certain terms in the algorithms may need to be approximated using the nonlinear speech distortion model. However, given the nonlinear nature of the distortion model in the log power spectra domain, a Piecewise Linear Approximation (PLA) of the nonlinear speech distortion model may be used to determine the terms required for the EM formulas.

Then the clean portion of the digital speech features x¹, or the noise-free speech features x¹, for each frame of digital speech waveform in the log power spectra domain may be determined using the statistical noise model, the log power spectra of the digital speech waveform, and the clean speech model to estimate the clean portion of the digital speech features x¹. In one implementation, a minimum mean-squared error (MMSE) estimation may be used to determine the clean portion of the digital speech features x¹.

A clean speech waveform may then be constructed from the clean portion of the digital speech's log power spectra along with the phase information ∠y^{f}(k) using the Inverse Discrete Fourier Transform (IDFT) of each frame's clean portion of the digital speech's spectra. A traditional overlap-add procedure for the window function may be used for waveform synthesis.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for creating a clean speech model in accordance with one or more implementations of various techniques described herein.

FIG. 3 illustrates a flow diagram of a method for removing noise from a digital speech waveform in accordance with one or more implementations of various techniques described herein.

### DETAILED DESCRIPTION

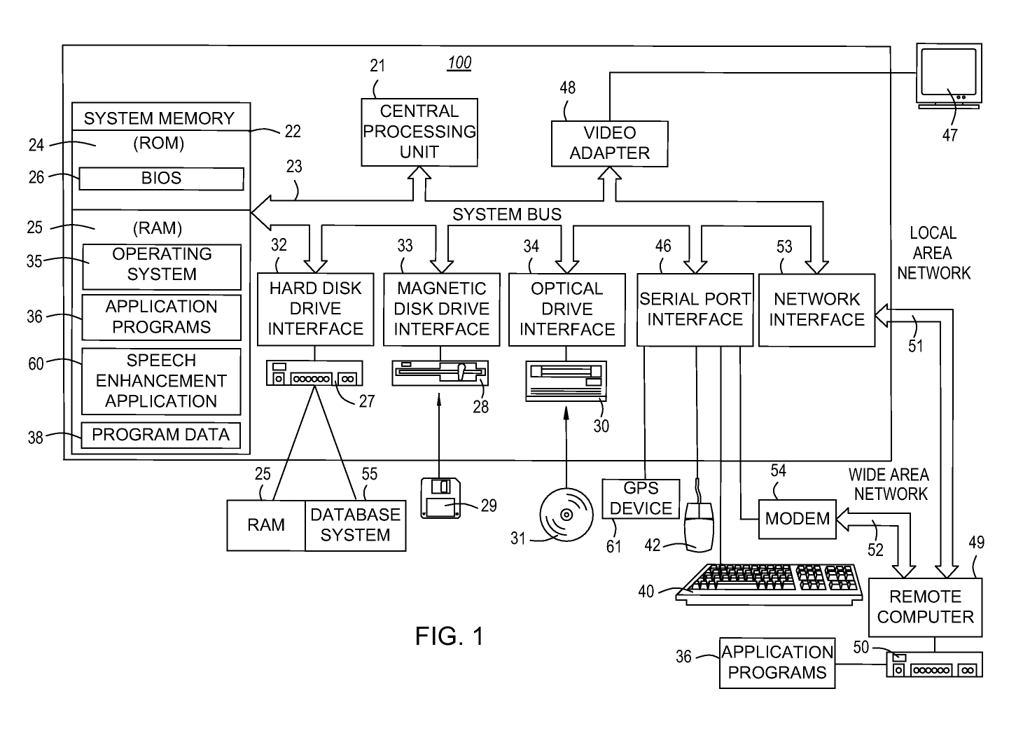

In general, one or more implementations described herein are directed to removing noise from a digital speech waveform. One or more implementations of various techniques for removing noise from a digital speech waveform will now be described in more detail with reference to FIGS. 1-3 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

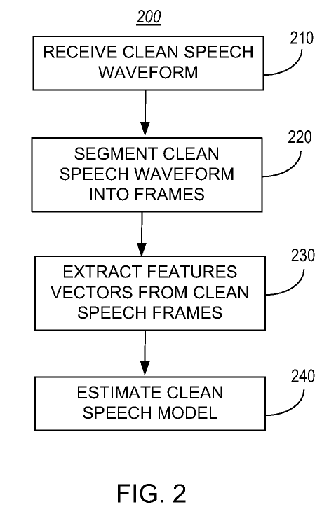

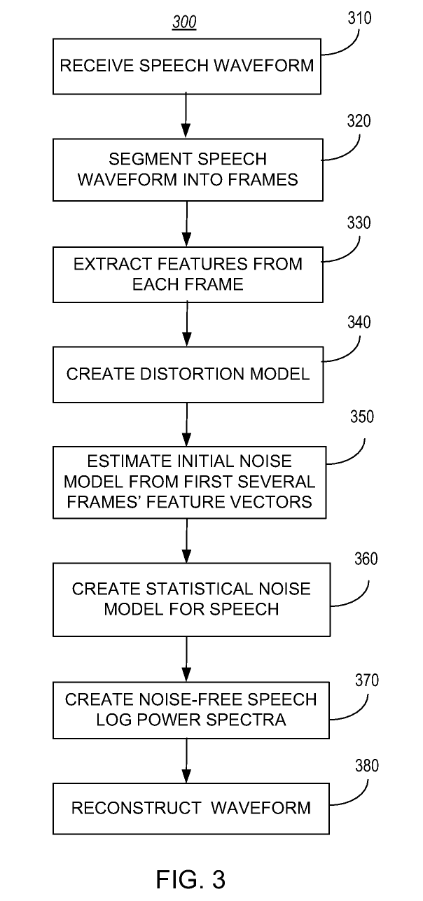

A number of program modules may be stored on the hard disk 27, magnetic disk 29, optical disk 31, ROM 24 or RAM 25, including an operating system 35, one or more application programs 36, a speech enhancement application 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The speech enhancement application 60 may be an application that may enable a user to remove noise from a digital speech waveform. The speech enhancement application 60 will be described in more detail with reference to FIGS. 2-3 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for creating a clean speech model in accordance with one or more implementations of various techniques described herein. The following description of method 200 is made with reference to computing system 100 of FIG. 1 in accordance with one or more implementations of various techniques described herein. Additionally, it should be understood that while the operational flow diagram indicates a particular order of execution of the operations, in some implementations, certain portions of the operations might be executed in a different order. In one implementation, the method 200 for creating a clean speech model may be performed by the speech enhancement application 60.

At step 210, the speech enhancement application 60 may receive a clean speech waveform or noise-free waveform from a user. In one implementation, the clean speech waveform may be a speech that has been recorded in a controlled environment where minimal noise factors may exist. The clean speech waveform may be uploaded or stored on the memory of the computing system 100 in a computer readable format such as a wave file, Moving Picture Experts Group Layer-3 Audio (MP3) file, or any other similar medium. The clean speech waveform may be used as a reference to distinguish noise from speech. In one implementation, the clean and digital speech waveform may be recorded in any language. In another implementation, in order to remove noise from a digital speech waveform, the clean speech waveform's language may need to match the digital speech waveform's language.

At step 220, the speech enhancement application 60 may segment the clean speech waveform into overlapped frames (windowed frames) such that two consecutive frames may half-overlap each other. In one implementation, each frame of clean speech may include 32 milliseconds of speech. The clean speech may include a sampling rate of 8 KHz such that there are 256 speech samples in each frame.

At step 230, the speech enhancement application 60 may extract a feature component from each frame of clean speech waveform created at step 220. In one implementation, the speech enhancement application 60 may compute a Discrete Fourier Transform (DFT) of each windowed frame such that:

$${x}^{f} ( k ) = {\sum }_{l = 0}^{L - 1} {x}^{t} ( l ) h ( l ) {e}^{- j2π kl / L} \qquad k = 0 , 1 , … , L - 1$$

where k is the frequency bin index, h(l) denotes the window (over-lapping) function, x^{t}(l) denotes the l^{th} speech sample in the current frame of the clean speech waveform in the time domain, x^{f}(k) denotes the clean speech spectra in the k^{th} frequency bin, and L represents the frame length. In one implementation, the window function may be a Hamming window.

Each feature component x^{f}(k) of the clean speech frame may be represented by a complex number containing a magnitude and a phase component. The speech enhancement application 60 may then calculate the log power spectra for each frame such that:

x¹(k)=log|x^{f}(k)|² k=0, 1, . . . , K−1

where

$$K = \frac{L}{2} + 1.$$

In this way, a K-dimensional feature component is extracted for each frame of clean speech.

At step 240, the speech enhancement application 60 may estimate a clean speech model given the set of feature components extracted from the clean speech waveform. In one implementation, the speech enhancement application 60 may use a Maximum Likelihood (ML) approach to create a Gaussian Mixture Model (GMM) of the clean speech feature components, which has M Gaussian components and M mixture coefficient weights, ωₘ, wherein m=1, 2, . . . , M.

FIG. 3 illustrates a flow diagram of a method 300 for removing noise from a digital speech waveform in accordance with one or more implementations of various techniques described herein. Additionally, it should be understood that while the operational flow diagram indicates a particular order of execution of the operations, in some implementations, certain portions of the operations might be executed in a different order. In one implementation, the method 300 for removing noise from a digital speech waveform may be performed by the speech enhancement application 60.

At step 310, the speech enhancement application 60 may receive a digital speech waveform from a user. In one implementation, the digital speech waveform may have been recorded in a digital medium in an area where noise exists.

At step 320, the speech enhancement application 60 may segment the digital speech waveform into overlapped frames of speech such that each consecutive frame may half-overlap each other. In one implementation, each frame of digital speech waveform may include 32 milliseconds of the recorded speech at a sampling rate of 8 KHz such that there are 256 speech samples in each frame. Each frame may be considered to have a noise-free, or clean, portion of the digital speech waveform and a noisy portion of the digital speech waveform.

At step 330, the speech enhancement application 60 may extract a feature component from each overlapping frame of the digital speech waveform created at step 320 to create a nonlinear speech distortion model for the digital speech waveform. The nonlinear speech distortion model may characterize how the digital speech waveform may be distorted. In one implementation, the speech enhancement application 60 may first compute the Discrete Fourier Transform (DFT) of each windowed (overlapping) frame such that:

$${y}^{f} ( k ) = {\sum }_{l = 0}^{L - 1} {y}^{t} ( l ) h ( l ) {e}^{- j2π kl / L} \qquad k = 0 , 1 , … , L - 1$$

where k is the frequency bin index, h(l) denotes the overlapping-window function, y^{t}(l) denotes the 1^{th} speech sample in the current frame of the digital speech waveform in the time domain, and y^{f}(k) denotes the digital speech spectra in the k^{th} frequency bin. In one implementation, the window function may be a Hamming window.

Each digital speech spectra y^{f}(k) may be represented by a complex number containing a magnitude (|y^{f}(k)|) and a phase component (∠y^{f}(k)). In one implementation, the speech enhancement application 60 may store the phase component (|y^{f}(k)) in the memory of the computing system 100 for later use. The speech enhancement application 60 may then calculate the log power spectra of the digital speech waveform for each frame such that:

y¹(k)=log|y^{f}(k)|² k=0, 1, . . . , K−1

where

$$K = \frac{L}{2} + 1.$$

In this way, a K-dimensional feature component is extracted for each frame of the digital speech waveform.

At step 340, the speech enhancement application 60 may create the nonlinear speech distortion model to characterize how the log power spectra of the digital speech waveform may be distorted. In order to create the nonlinear speech distortion model, the speech enhancement application 60 may assume that the speech waveform may be modeled in the time domain as:

y^{t}(l)=x^{t}(l)+n^{t}(l)

where x^{t}(l) represents the clean portion, or noise-free, of the digital speech waveform y^{t}(l), and n^{t}(l) represents the noisy portion of the digital speech waveform. y^{t}(l), x^{t}(l) and n^{t}(l) represents the 1^{th} sample of the relevant signals respectively. In the frequency domain, the speech signal may be represented as:

y^{f}=x^{f}+n^{f}

where y^{f}, x^{f}, and n^{f} represent the spectra of the digital speech waveform, the clean portion of the digital speech waveform, and the noisy portion of the digital speech waveform, respectively. By ignoring correlations among different frequency bins, the nonlinear speech distortion model of the digital speech waveform in the log power spectra domain may be expressed approximately as:

exp(y¹)=exp(x¹)+exp(n¹)

where y¹, x¹, and n¹ represent the log power spectra of the digital speech waveform, the clean portion of the digital speech waveform, and the noisy portion of the digital speech waveform, respectively. In one implementation, the speech enhancement application 60 may assume that the additive noise log power spectra n¹ may be statistically modeled as a Gaussian Probability Density Function (PDF) with a mean vector μₙ and a diagonal covariance matrix

[symbol]

At step 350, the speech enhancement application 60 may examine the feature components from the first several frames of the digital speech waveform and create a nonlinear speech distortion model for the digital speech waveform. In one implementation, the speech enhancement application 60 may assume that the first ten frames of the digital speech waveform may be composed of pure noise. The initial estimation of the nonlinear speech distortion model parameters μₙ and [symbol] may then be taken as the sample mean and the sample covariance of the feature components extracted from the first ten frames of the speech waveform.

At step 360, the speech enhancement application 60 may create a statistical noise model for the whole digital speech waveform. Here, the speech enhancement application 60 may make a maximum likelihood (ML) estimation of a mean vector μₙ and a diagonal covariance matrix [symbol] of the statistical noise model using an iterative Expectation-Maximization (EM) algorithm. In one implementation, the ML estimation may be obtained by using feature components extracted from all of the frames of the digital speech waveform. The ML estimation of the mean vector μₙ and the diagonal covariance matrix [symbol] may be determined by iteratively updating the following EM formulas:

$${\overline{μ}}_{n} = \frac{{\sum }_{t = 0}^{T - 1} {\sum }_{m = 1}^{M} P ( m \vert {y}_{t}^{l} ) {E}_{n} [ ( {n}_{t}^{l} \vert {y}_{t}^{l} , m ) ]}{{\sum }_{t = 0}^{T - 1} {\sum }_{m = 1}^{M} P ( m \vert {y}_{t}^{l} )}$$

$$= \frac{{\sum }_{t = 0}^{T - 1} {\sum }_{m = 1}^{M} P ( m \vert {y}_{t}^{l} ) {E}_{n} [ ( {{n}_{t}^{l} ( {n}_{t}^{l} )}^{T} \vert {y}_{t}^{l} , m ) ]}{{\sum }_{t = 0}^{T - 1} {\sum }_{m = 1}^{M} P ( m \vert {y}_{t}^{l} )} - {\overline{μ}}_{n} {\overline{μ}}_{n}^{T}$$

$$where$$

$$P ( m \vert {y}_{t}^{l} ) = \frac{{ω}_{m} {p}_{y} ( {y}_{t}^{l} \vert m )}{{\sum }_{l = 1}^{M} {ω}_{l} {p}_{y} ( {y}_{t}^{l} \vert l )}$$

and where p_{y}(yₜ¹|m) represents the Probability Density Function (PDF) of the digital speech feature component, yₜ^{l}, for the m^{th} component of the mixture of densities, Eₙ[(nₜ^{l}|yₜ^{l},m)] and Eⁿ[(nₜ^{l}(nₜ^{l})^{T}|yₜ^{l},m)] are relevant conditional expectations, and t is the frame index. In one implementation, the speech enhancement application 60 may perform one or more iterations of the EM formulas listed above in order to more accurately statistically model the noise of the digital speech waveform. In one implementation, the statistical noise model may be used to characterize the additive noise log power spectra feature component n¹.

However, given the nonlinear nature of the digital speech's distortion model in the log power spectra domain:

exp(y¹)=exp(x¹)+exp(n¹)

it may be difficult to calculate the above-mentioned terms without making further approximations. As such, the speech enhancement application 60 may use a Piecewise Linear Approximation (PLA) of the nonlinear speech distortion function y¹ such that the detailed formulas for calculating the terms, p_{y}(yₜ^{l}|m), Eₙ[(nₜ^{l}|yₜ^{l},m), and Eₙ[(nₜ^{l}(nₜ^{l})^{T}|y_{y}^{l},m), can be derived accordingly.

At step 370, the speech enhancement application 60 may determine the clean portion of the digital speech features x¹ (noise-free speech log power spectra) for each frame of the digital speech waveform in the log power spectral domain. In one implementation, the speech enhancement application 60 may use the statistical noise model determined at step 360, the log power spectra of each digital speech waveform's frame determined at step 330, and the clean speech model determined at step 240 to estimate the clean portion of the digital speech features x¹ from the digital speech features y¹. The speech enhancement application 60 may use a minimum mean-squared error (MMSE) estimation of the clean portion of the digital speech features x¹ which may be calculated as:

$${\hat{x}}_{t}^{l} = {E}_{x} [ ( {x}_{t}^{l} \vert {y}_{t}^{l} ) ] = {\sum }_{m = 1}^{M} P ( m \vert {y}_{t}^{l} ) {E}_{x} [ ( {x}_{t}^{l} \vert {y}_{t}^{l} , m ) ]$$

where Eₓ[(xₜ^{l}|yₜ^{l},m)] is the conditional expectation of xₜ^{l} given yₜ^{l} for the m^{th} mixture component. The speech enhancement application 60 may again use PLA approximation of the nonlinear speech distortion model to derive the detailed formula for calculating Eₓ[(xₜ^{l}|yₜ^{l},m)].

At step 380, the speech enhancement application 60 may construct a clean portion of the digital speech waveform from the clean portion of the digital speech features x¹ created at step 370. In one implementation, the speech enhancement application 60 may use the clean portion of the digital speech features x¹ created at step 370 and the phase information for each frame of the speech waveform created at step 330 as inputs into a wave reconstruction function. A reconstructed spectra may be defined as:

\hat{x}^{f}(k)=exp{\hat{x}^{l}(k)/2}exp{j∠y^{f}(k)}

where the phase information ∠y^{f}(k) is derived at step 330 from the digital speech waveform. The speech enhancement application 60 may then reconstruct the clean portion of the digital speech waveform by computing the Inverse Discrete Fourier Transform (IDFT) of each frame of the reconstructed spectra as follows:

$${\hat{x}}^{t} ( l ) = \frac{1}{L} {\sum }_{k = 0}^{L - 1} {\hat{x}}^{f} ( k ) {e}^{j2π kl / L} \qquad l = 0 , 1 , … , L - 1$$

In one implementation, the waveform free of additive noise for the whole speech may then be synthesized using a traditional overlap-add procedure where the window function defined in step 320 may be used for waveform synthesis.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for removing noise from a digital speech waveform, comprising:
receiving the digital speech waveform having the noise contained therein;
segmenting the digital speech waveform into one or more frames, each frame having a clean portion and a noisy portion;
extracting a feature component from each frame;
creating a nonlinear speech distortion model from the feature components;
creating a statistical noise model by making a Piecewise Linear Approximation (PLA) of the nonlinear speech distortion model;
determining the clean portion of each frame using the statistical noise model, a log power spectra of each frame, and a model of a digital speech waveform recorded in a noise controlled environment; and
constructing a clean digital speech waveform from each clean portion of each frame.

2. The method of claim 1, wherein the model is a Gaussian Mixture Model (GMM).

3. The method of claim 1, wherein the frames comprise 32 milliseconds of speech and are positioned such that two consecutive frames half over-laps each other.

4. The method of claim 1, wherein extracting the feature component comprises:
computing a Discrete Fourier Transform (DFT) of each frame y^{f}(k) such that
$${y}^{f} ( k ) = {\sum }_{l = 0}^{L - 1} {y}^{t} ( l ) h ( l ) {e}^{- j2π kl / L} \qquad k = 0 , 1 , … , L - 1$$
where k is a frequency bin index, h(l) denotes a window function, y^{t}(l) denotes a l^{th} speech sample in a current frame of the digital speech waveform in a time domain, the frame y^{f}(k) denotes the digital speech spectra in a k^{th} frequency bin, and L represents a frame length;
representing each frame y^{f}(k) with a complex number comprising a magnitude component and a phase component; and
calculating a log power spectra of each frame y^{f}(k) such that:
y¹(k)=log|y^{f}(k)|² k=0, 1, . . . , K−1
where
$$K = \frac{L}{2} + 1 ,$$
and |y^{f}(k)| is the magnitude component.

5. The method of claim 1, wherein creating the nonlinear speech distortion model comprises:
modeling the digital speech waveform in a log power spectra domain such that:
exp(y¹)=exp(x¹)+exp(n¹)
where y¹, represents a log power spectra of the digitial speech waveform, x¹ represents a log power spectra of a clean portion of the digital speech waveform, and n¹ represents a log power spectra of a noisy portion of the digital speech waveform;
modeling the log power spectra of the noisy portion n¹ statistically as a Gaussian Probability Density Function (PDF) with a mean vector μₙ and a diagonal covariance matrix [symbol] ;
determining a sample mean μₙ and a sample covariance [symbol] from the feature components of a first ten frames; and
calculating the nonlinear speech distortion model using the sample mean μₙ and the sample covariance

[symbol]

6. The method of claim 5, wherein creating the statistical noise model comprises:
determining a maximum likelihood (ML) estimation of the mean vector μₙ and the diagonal covariance matrix [symbol] using a Expectation-Maximization (EM) algorithm such that:
$${\overline{μ}}_{n} = \frac{{\sum }_{t = 0}^{T - 1} {\sum }_{m = 1}^{M} P ( m \vert {y}_{t}^{l} ) {E}_{n} [ ( {n}_{t}^{l} \vert {y}_{t}^{l} , m ) ]}{{\sum }_{t = 0}^{T - 1} {\sum }_{m = 1}^{M} P ( m \vert {y}_{t}^{l} )}$$
$$= \frac{{\sum }_{t = 0}^{T - 1} {\sum }_{m = 1}^{M} P ( m \vert {y}_{t}^{l} ) {E}_{n} [ ( {{n}_{t}^{l} ( {n}_{t}^{l} )}^{T} \vert {y}_{t}^{l} , m ) ]}{{\sum }_{t = 0}^{T - 1} {\sum }_{m = 1}^{M} P ( m \vert {y}_{t}^{l} )} - {\overline{μ}}_{n} {\overline{μ}}_{n}^{T}$$
$$where$$
$$P ( m \vert {y}_{t}^{l} ) = \frac{{ω}_{m} {p}_{y} ( {y}_{t}^{l} \vert m )}{{\sum }_{l = 1}^{M} {ω}_{l} {p}_{y} ( {y}_{t}^{l} \vert l )}$$
where p_{y}(yₜ^{l}|m) represents a Probability Density Function (PDF) of the digital speech waveform's feature component yₜ^{l}, for an m^{th} component of a mixture of densities, where Eₙ[(nₜ^{l}|yₜ^{l},m)] and Eₙ[(nₜ^{l}(nₜ^{l})^{T}|yₜ^{l},m)] are relevant conditional expectations, and where t is a frame index; and
using the Piecewise Linear Approximation (PLA) of the nonlinear speech distortion model to calculate p_{y}(yₜ^{l}|m),
Eₙ[(nₜ^{l}|yₜ^{l},m), and Eₙ[(nₜ^{l}(nₜ^{l})^{T}|yₜ^{l},m).

7. The method of claim 6, wherein the clean portion of each frame is represented in the log power spectra domain.

8. The method of claim 7, wherein determining the clean portion of each frame comprises:
using a minimum mean-squared error (MMSE) estimation of the log power spectra of the clean portion of the digital speech waveform x^{l} such that:
$${\hat{x}}_{t}^{l} = {E}_{x} [ ( {x}_{t}^{l} \vert {y}_{t}^{l} ) ] = {\sum }_{m = 1}^{M} P ( m \vert {y}_{t}^{l} ) {E}_{x} [ ( {x}_{t}^{l} \vert {y}_{t}^{l} , m ) ]$$
where Eₓ[(xₜ^{l}|yₜ^{l},m)] is a conditional expectation of the log power spectra of the clean portion of the digital speech waveform xₜ^{l} given the log power spectra of the digital speech waveform yₜ^{l} for the m^{th} component of the mixture of densities; and
using the Piecewise Linear Approximation (PLA) of the nonlinear speech distortion model to calculate Eₓ[(xₜ^{l}|yₜ^{l},m)].

9. The method of claim 7, wherein constructing the clean digital speech waveform comprises:
using each log power spectra of the clean portion of the digital speech waveform and a phase component corresponding thereto as inputs in a wave reconstruction function such that:
\hat{x}^{f}(k)=exp{\hat{x}^{t}(k)/2}exp{j∠y^{f}(k)}
where ∠y^{f}(k) is the phase component from the digital speech waveform to create a reconstructed spectra from each log power spectra;
converting each reconstructed spectra of the clean portion of the digital speech; waveform to a time domain using an Inverse Discrete Fourier Transform (IDFT) such that:
$${\hat{x}}^{t} ( l ) = \frac{1}{L} {\sum }_{k = 0}^{L - 1} {\hat{x}}^{f} ( k ) {e}^{j2π kl / L} ; and$$
synthesizing the digital speech waveform using a traditional overlap-add procedure.

10. A computer-readable medium having stored thereon computer-executable instructions which, when executed by a computer, cause the computer to:
receive the digital speech waveform having the noise contained therein;
segment the digital speech waveform into one or more frames, each frame having a clean portion and a noisy portion represented in a log power spectra domain;
extract a feature component from each frame;
create a nonlinear speech distortion model from the feature components;
create a statistical noise model by making a Piecewise Linear Approximation (PLA) of the nonlinear speech distortion model to derive one or more terms in an Expectation-Maximization (EM) algorithm;
determine the clean portion of each frame using the statistical noise model, a log power spectra of each frame, and a Gaussian Mixture Model (GMM) model of a digital speech waveform recorded in a noise controlled environment; and
construct a clean digital speech waveform from each clean portion of each frame.

11. The computer-readable medium of claim 10, wherein the frames comprise 32 milliseconds of speech and are positioned such that two consecutive frames half over-laps each other.

12. The computer-readable medium of claim 10, wherein the computer-executable instructions to create the nonlinear speech distortion model are configured to:
model the digital speech waveform in the log power spectra domain such that:
exp(y¹)=exp(x¹)+exp(n¹)
where y¹, represents a log power spectra of the digitial speech waveform, x¹ represents a log power spectra of a clean portion of the digital speech waveform, and n¹ represents a log power spectra of a noisy portion of the digital speech waveform;
model the log power spectra of the noisy portion n¹ statistically as a Gaussian Probability Density Function (PDF) with a mean vector μₙ and a diagonal covariance matrix [symbol]
determine a sample mean μₙ and a sample covariance [symbol] from the feature components of a first ten frames; and
calculate the nonlinear speech distortion model using the sample mean μₙ and the sample covariance

[symbol]

13. The computer-readable medium of claim 12, wherein the computer-executable instructions to create the statistical noise model are configured to:
determine a maximum likelihood (ML) estimation of the mean vector μₙ and the diagonal covariance matrix [symbol] using a Expectation-Maximization (EM) algorithm such that:
$${\overline{μ}}_{n} = \frac{{\sum }_{t = 0}^{T - 1} {\sum }_{m = 1}^{M} P ( m \vert {y}_{t}^{l} ) {E}_{n} [ ( {n}_{t}^{l} \vert {y}_{t}^{l} , m ) ]}{{\sum }_{t = 0}^{T - 1} {\sum }_{m = 1}^{M} P ( m \vert {y}_{t}^{l} )}$$
$$= \frac{{\sum }_{t = 0}^{T - 1} {\sum }_{m = 1}^{M} P ( m \vert {y}_{t}^{l} ) {E}_{n} [ ( {{n}_{t}^{l} ( {n}_{t}^{l} )}^{T} \vert {y}_{t}^{l} , m ) ]}{{\sum }_{t = 0}^{T - 1} {\sum }_{m = 1}^{M} P ( m \vert {y}_{t}^{l} )} - {\overline{μ}}_{n} {\overline{μ}}_{n}^{T}$$
$$where$$
$$P ( m \vert {y}_{t}^{l} ) = \frac{{ω}_{m} {p}_{y} ( {y}_{t}^{l} \vert m )}{{\sum }_{l = 1}^{M} {ω}_{l} {p}_{y} ( {y}_{t}^{l} \vert l )}$$
where p_{y}(yₜ^{l}|m) represents a Probability Density Function (PDF) of the digital speech waveform's feature component yₜ^{l}, for an m^{th} component of a mixture of densities, where Eₙ[(nₜ^{l}|yₜ^{l},m)] and Eₙ[(nₜ^{l}(nₜ^{l})^{T}|yₜ^{l},m)] are relevant conditional expectations, and where t is a frame index; and
use the Piecewise Linear Approximation (PLA) of the nonlinear speech distortion model to derive one or more detailed formulas to calculate p_{y}(yₜ^{l}|m), Eₙ[(nₜ^{l}|yₜ^{l},m), and Eₙ[(nₜ^{l}(nₜ^{l})^{T}|yₜ^{l},m).

14. The computer-readable medium of claim 12, wherein the computer-executable instructions to construct the clean digital speech waveform are configured to:
use each log power spectra of the clean portion of the digital speech waveform and a phase component corresponding thereto as inputs in a wave reconstruction function such that:
\hat{x}^{f}(k)=exp{\hat{x}^{l}(k)/2}exp{j∠y^{f}(k)}
where ∠y^{f}(k) is the phase component from the digital speech waveform to create a reconstructed spectra from each log power spectra;
convert each reconstructed spectra of the clean portion of the digital speech waveform to a time domain using an Inverse Discrete Fourier Transform (IDFT) such that:
$${\hat{x}}^{t} ( k ) = \frac{1}{L} {\sum }_{k = 0}^{L - 1} {\hat{x}}^{f} ( k ) {e}^{j2π kl / L} ; and$$
synthesizing the digital speech waveform using a traditional overlap-add procedure.

15. A computer system, comprising:
a processor; and
a memory comprising program instructions executable by the processor to:
receive the digital speech waveform having the noise contained therein;
segment the digital speech waveform into one or more frames, each frame having 32 milliseconds of speech, being positioned such that two consecutive frames half over-laps each other, and each frame having a clean portion and a noisy portion and the frames;
extract a feature component from each frame;
create a nonlinear speech distortion model from the feature components;
create a statistical noise model by making a Piecewise Linear Approximation (PLA) of the nonlinear speech distortion model;
determine the clean portion of each frame using the statistical noise model, a log power spectra of each frame, and a model of a digital speech waveform recorded in a noise controlled environment; and
construct a clean digital speech waveform from each clean portion of each frame.

16. The computer system of claim 15, wherein the model is a Gaussian Mixture Model (GMM).

17. The computer system of claim 15, wherein the frames comprise 32 milliseconds of speech and are positioned such that two consecutive frames half over-laps each other.

18. The computer system of claim 15, wherein the program instructions executable the processor to extract the feature component comprise program instructions executable by the processor to:
compute a Discrete Fourier Transform (DFT) of each frame y^{f}(k) such that
$${y}^{f} ( k ) = {\sum }_{l = 0}^{L - 1} {y}^{t} ( l ) h ( l ) {e}^{- j2π kl / L} \qquad k = 0 , 1 , … , L - 1$$
where k is a frequency bin index, h(l) denotes a window function, y^{t}(l) denotes a l^{th} speech sample in a current frame of the digital speech waveform in a time domain, the frame y^{f}(k) denotes the digital speech spectra in a k^{th} frequency bin, and L represents a frame length;
represent each frame y^{f}(k) with a complex number comprising a magnitude component and a phase component; and
calculate a log power spectra of each frame y^{f}(k) such that:
y^{l}(k)=log|y^{f}(k)|² k=0, 1, . . . , K−1
where
$$K = \frac{L}{2} + 1 ,$$
and |y^{f}(k)| is the magnitude component.

19. The computer system of claim 15, wherein the program instructions executable the processor to create the nonlinear speech distortion model comprise program instructions executable by the processor to:
model the digital speech waveform in a log power spectra domain such that:
exp(y¹)=exp(x¹)+exp(n¹)
where y¹ represents a log power spectra of the digitial speech waveform, x¹ represents a log power spectra of a clean portion of the digital speech waveform, and n¹ represents a log power spectra of a noisy portion of the digital speech waveform;
model the log power spectra of the noisy portion n¹ statistically as a Gaussian Probability Density Function (PDF) with a mean vector μₙ and a diagonal covariance matrix [symbol]
determine a sample mean μₙ and a sample covariance [symbol] from the feature components of a first ten frames; and
calculate the nonlinear speech distortion model using the sample mean μₙ and the sample covariance

[symbol]

20. The computer system of claim 19, wherein the program instructions executable the processor to create the statistical noise model comprise program instructions executable by the processor to:
determine a maximum likelihood (ML) estimation of the mean vector μₙ and the diagonal covariance matrix [symbol] using a Expectation-Maximization (EM) algorithm such that:
$${\overline{μ}}_{n} = \frac{{\sum }_{t = 0}^{T - 1} {\sum }_{m = 1}^{M} P ( m \vert {y}_{t}^{l} ) {E}_{n} [ ( {n}_{t}^{l} \vert {y}_{t}^{l} , m ) ]}{{\sum }_{t = 0}^{T - 1} {\sum }_{m = 1}^{M} P ( m \vert {y}_{t}^{l} )}$$
$$= \frac{{\sum }_{t = 0}^{T - 1} {\sum }_{m = 1}^{M} P ( m \vert {y}_{t}^{l} ) {E}_{n} [ ( {{n}_{t}^{l} ( {n}_{t}^{l} )}^{T} \vert {y}_{t}^{l} , m ) ]}{{\sum }_{t = 0}^{T - 1} {\sum }_{m = 1}^{M} P ( m \vert {y}_{t}^{l} )} - {\overline{μ}}_{n} {\overline{μ}}_{n}^{T}$$
$$where$$
$$P ( m \vert {y}_{t}^{l} ) = \frac{{ω}_{m} {p}_{y} ( {y}_{t}^{l} \vert m )}{{\sum }_{l = 1}^{M} {ω}_{l} {p}_{y} ( {y}_{t}^{l} \vert l )}$$
where p_{y}(yₜ^{l}|m) represents a Probability Density Function (PDF) of the digital speech waveform's feature component yₜ^{l}, for an m^{th} component of a mixture of densities, where Eₙ[(nₜ^{l}|yₜ^{l},m)] and Eₙ[(nₜ^{l}(nₜ^{l})^{T}|yₜ^{l},m)] are relevant conditional expectations, and where t is a frame index; and
use the Piecewise Linear Approximation (PLA) of the nonlinear speech distortion model to derive one or more detailed formulas to calculate p_{y}(yₜ^{l}|m), Eₙ[(nₜ^{l}|yₜ^{l},m), and Eₙ[(nₜ^{l}(nₜ^{l})^{T}|yₜ^{l},m).
